(19) United States
(12) Patent Application Publication
(10) Pub. No.: US 2011/0146871 A1
(43) Pub. Date: Jun. 23, 2011

(54) SELF-SUPPORTING PNEUMATIC TIRE

(76) Inventors: Richard Frank Laske, Akron, OH (US); Robert Allen Losey, Kent, OH (US); Thulasiram Gobinath, Hudson, OH (US); Samuel Patrick Landers, North Canton, OH (US)

(21) Appl. No.: 12/955,097

(22) Filed: Nov. 29, 2010

Related U.S. Application Data
(60) Provisional application No. 61/289,804, filed on Dec. 23, 2009.

(51) Int. Cl. B60C 17/04; B29D 30/08

(52) U.S. Cl. 152/517; 156/117

(57) ABSTRACT

The present invention is directed to a self-supporting tire. More specifically, the tire has a carcass, a tread, and a belt reinforcing structure located radially outward of the carcass and radially inward of the tread. The carcass is comprised of a reinforcing ply structure extending between a pair of bead portions and having a geodesic configuration. The tire further includes a pair of sidewalls, each sidewall located radially outward of one of the pair of bead portions, and a pair of inserts located in each sidewall. A first insert and second insert are located between the innerliner and the ply.

### CROSS REFERENCE TO OTHER APPLICATIONS

This application claims the benefit of and incorporates by reference U.S. Provisional Application No. 61/289,804 filed Dec. 23, 2009.

### FIELD OF THE INVENTION

The present invention is directed to a pneumatic radial tire capable of running in conditions wherein the tire is operated at less than conventional inflation pressure.

### BACKGROUND OF THE INVENTION

Self-supporting run-flat tires have been commercialized for many years. The primary characteristic of such tires is an increase in the cross-sectional thickness of the sidewalls to strengthen the sidewalls. These tires, when operated in the uninflated condition, place the reinforcing sidewall inserts in compression. Due to the large amounts of rubber required to stiffen the sidewall members, heat build-up is a major factor in tire failure. This is especially true when the tire is operated for prolonged periods at high speeds in the uninflated condition.

U.S. Pat. No. 5,368,082 teaches the employment of special sidewall inserts to improve stiffness. Approximately six additional pounds of weight per tire are required to support an 800 lb load in an uninflated tire. The earliest commercial use of such runflat tires were used on a high performance vehicle and had a very low aspect ratio. The required supported weight for an uninflated luxury car tire, having an aspect ratios in the 55% to 65% range or greater, approximates 1400 lbs load. Such higher loads for larger run-flat tires meant that the sidewalls and overall tire had to be stiffened to the point of compromising ride. Luxury vehicle owners simply will not sacrifice ride quality for runflat capability. The engineering requirements have been to provide a runflat tire with no loss in ride or performance. In the very stiff suspension performance type vehicle the ability to provide such a tire was comparatively easy when compared to luxury sedans with a softer ride characteristic. Light truck and sport utility vehicles, although not as sensitive to ride performance, provide a runflat tire market that ranges from accepting a stiffer ride to demanding the softer luxury type ride.

It is thus desired to provide a novel run on flat tire design that is a “soft” run on flat design, so that no compromise in comfort is required while having the same chassis loading as a regular pneumatic tire.

### SUMMARY OF THE INVENTION

The present invention is directed to a self-supporting tire. More specifically, the tire has a carcass, a tread, and a belt reinforcing structure located radially outward of the carcass and radially inward of the tread. The carcass is comprised of a reinforcing ply structure having a geodesic cord construction extending between a pair of bead portions, a pair of sidewalls, each sidewall located radially outward of one of the pair of bead portions, and a pair of inserts located in each sidewall. A first insert and second insert are located between the innerliner and the ply.

### Definitions

The following definitions are controlling for the disclosed invention.

“Annular”; formed like a ring.

“Axial” and “axially” are used herein to refer to lines or directions that are parallel to the axis of rotation of the tire.

“Circumferential” means lines or directions extending along the perimeter of the surface of the annular tire parallel to the Equatorial Plane (EP) and perpendicular to the axial direction.

“Design rim” means a rim having a specified configuration and width. For the purposes of this specification, the design rim and design rim width are as specified by the industry standards in effect in the location in which the tire is made. For example, in the United States, the design rims are as specified by the Tire and Rim Association. In Europe, the rims are as specified in the European Tyre and Rim Technical Organization—Standards Manual and the term design rim means the same as the standard measurement rims. In Japan, the standard organization is The Japan Automobile Tire Manufacturer's Association.

“Design rim width” is the specific commercially available rim width assigned to each tire size.

“Inner” means toward the inside of the tire and “outer” means toward its exterior.

“Self-supporting run-flat” means a type of tire that has a structure wherein the tire structure alone is sufficiently strong to support the vehicle load when the tire is operated in the uninflated condition for limited periods of time and speed, the sidewall and internal surfaces of the tire not collapsing or buckling onto themselves, without requiring any internal devices to prevent the tire from collapsing.

“Sidewall insert” means elastomer or cord reinforcements located in the sidewall region of a tire; the insert being in addition to the carcass reinforcing ply and outer sidewall rubber that forms the outer surface of the tire.

“Spring Rate” means the stiffness of tire expressed as the slope of the load deflection curve at a given pressure.

“Vertical Deflection” means the amount that a tire deflects under load.

### BRIEF DESCRIPTION OF THE DRAWINGS

The invention will be described by way of example and with reference to the accompanying drawings in which:

FIG. 1 is a perspective view of a tire carcass having geodesic cords;

FIG. 2 is a close up view of the cords of the tire carcass in the crown area;

FIG. 3 is a close up view of the cords of the tire carcass in the bead area;

FIG. 4A illustrates the initial cord winding on a tire blank in a geodesic pattern;

FIG. 4B illustrates the cord winding on a tire blank of FIG. 5a after multiple passes;

FIG. 5 illustrates various geodesic curves;

FIG. 6 illustrates a front view of a tire carcass having geodesic cords of the present invention;

FIG. 7 illustrates a side view of the carcass of FIG. 7;

FIGS. 8 and 9 illustrate a close up perspective view of the bead area of the carcass of FIG. 7;

FIGS. 10-11 illustrate a first embodiment of an apparatus for laying ply on a tire blank;

FIG. 12 illustrates a second embodiment of an apparatus for laying ply on a tire blank;

FIG. 13 is a cross-sectional configuration of a self-supporting run-flat tire; and

FIG. 14 compares the cross-sectional profile of a typical radial run flat tire as compared to the tire of the present invention.

### DETAILED DESCRIPTION OF THE INVENTION

FIG. 13 illustrates a tire 300 of the present invention that is designed to be operable should a loss of air pressure occur. The tire 300 has a radially outer ground engaging tread 320, and a belt structure 330 located in the crown portion of the tire underneath the tread. The belt structure 330 contains one or more belts with an optional shoulder overlay 360 to protect the belts at the shoulder portion of the crown. The tire 300 further comprises a pair of sidewall portions 380 which extend radially inward from the tread and terminate in a bead region 325. Each bead region further comprises a single column of bead wire 355 located axially inward of the ply. The bead portion may also include other optional and non-illustrated elements such as flippers, chippers, toe guards and chafers.

The tire 300 of the present invention further includes an inner liner 342 which is air impervious, and extends from one bead region 325 to the other. The carcass also includes a reinforcing ply 340 which may comprise any of the embodiments or combinations described in more detail, below. The reinforcing ply 340 extends under the crown portion of the tire and axially outwards of a first insert 344 in the upper shoulder area of the tire. The first insert 344 is located in the upper shoulder area near the crown, and is located between the innerliner 324 and the reinforcing ply 340. The reinforcing ply 340 extends axially outward and adjacent the axially outer portion 343 of the first insert 344. The reinforcing ply also extends axially outward and adjacent the axially outer portion 354 of a second insert 350. Thus, the first reinforcing ply transitions from an axially outward position in the upper shoulder area of the tire to an axially inward position in the bead region 325. In the bead region of the tire, the reinforcing ply 340 forms a build up 332 of ply axially outward and adjacent the bead 355.

As described above, the tire of this embodiment further includes an optional chafer 370. The chafer 370 is located between the sidewall 380 and the ply 340. The chafer 370 has a radially inner end 372 located near the radially outer portion of the bead wire 355, and a radially outer end 374 that extends in the range from about ⅓ to about ½ the height of the sidewall. The chafer 370 is typically formed of an elastomer or rubber having a Shore A hardness at 23 degrees C. in the range of 50 to about 90, more preferably about 60 to about 80.

The first insert 344 may be crescent shaped or curved. The first insert 344 preferably has a maximum thickness B at a location between the tread edge and the radial location of the upper sidewall of the tire. B ranges from about 4 to about 6 mm and occurs at a radial height of about ⅔ of the section height. The first insert 344 may be formed of an elastomer or rubber having a Shore A hardness at 23 degrees C. in the range of 50 to about 75, more preferably about 55 to about 65. The function of the first insert 344 is to stiffen/support the sidewall 380 of the tire 300 and to keep the ply under tension when the tire 300 is operated at reduced or insignificant inflation pressure.

The radially outer end 351 of the second insert preferably overlaps with the first insert 344. The curvature of the axially inner surface of the second insert is concave in the radially outer portion and convex in the radially inner portion. The optional second insert has a different shore A hardness than the first insert 344, and it is preferred that the second insert be stiffer relative to the first insert. Thus the second insert has a higher relative shore A hardness than the first insert 40.

The inserts 344, 350 are elastomeric in nature and may have material properties selected to enhance inflated ride performance while promoting the tire's run-flat durability. The inserts 344, 350 if desired, may also be individually reinforced with polyethylene or short fibers. Thus, one or more of such inserts 344, 350 may be so reinforced. The inserts 344, 350 may have a tangent delta in the range of about 0.02 to about 0.06, and more preferably in the range of about 0.025 and 0.045. The tangent delta is measured under shear at 70 degrees C., and under a deformation of 6%, using a Metravib analyzer at a frequency of 7.8 Hertz.

### Ply Configuration

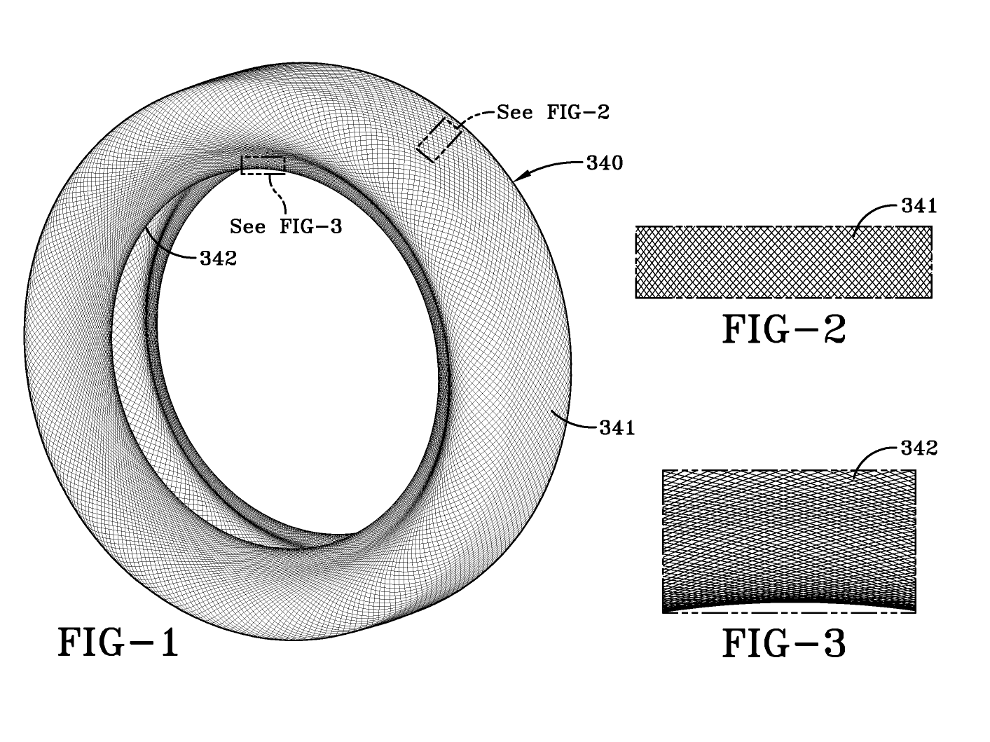

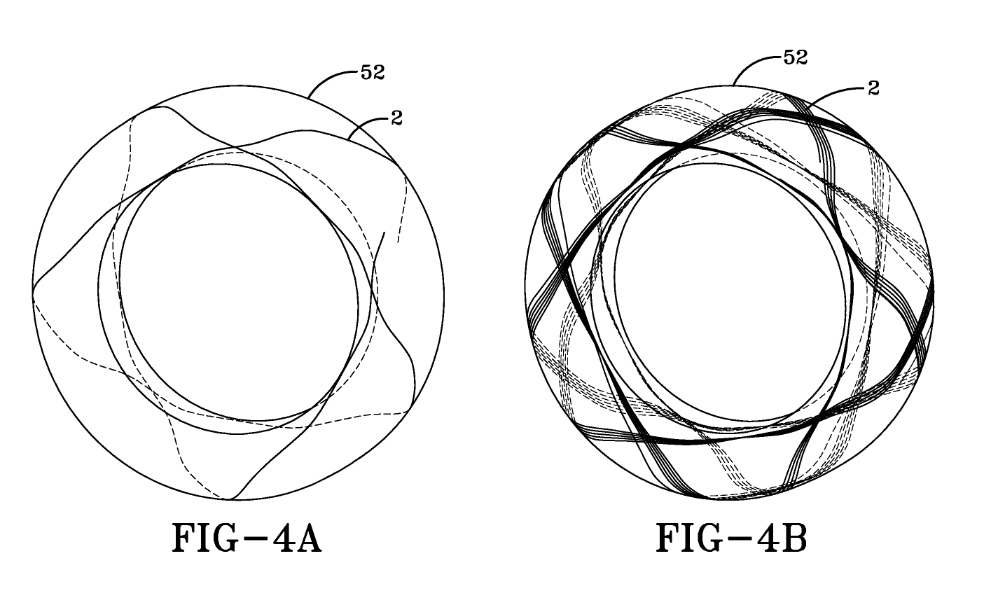

FIGS. 1-3 illustrate the tire carcass 340 of the present invention wherein the cords are arranged in geodesic lines. As shown in FIG. 2, the crown portion 341 of an exemplary passenger tire of size 225 60R16 has spaced apart plies with the angle of about 48 degrees (which varies depending upon the overall tire size). As shown in FIG. 3, the bead area 342 of the tire has closely spaced cords with the cords tangent to the bead. Thus the ply angle continuously changes from the bead core to the crown. A geodesic path on any surface is the shortest distance between two points or the least curvature. On a curved surface such as a torus, a geodesic path is a straight line. A true geodesic ply pattern follows the mathematical equation exactly:

ρcosα=ρ₀cosα₀

wherein ρ is the radial distance from the axis of rotation of the core to the cord at a given location;

a is the angle of the ply cord at a given location with respect to the mid-circumferential plane;

ρ₀ is the radial distance from the axis of rotation of the core to the crown at the circumferential plane, and α₀ is the angle of the ply cord with respect to the tread centerline or midcircumferential plane.

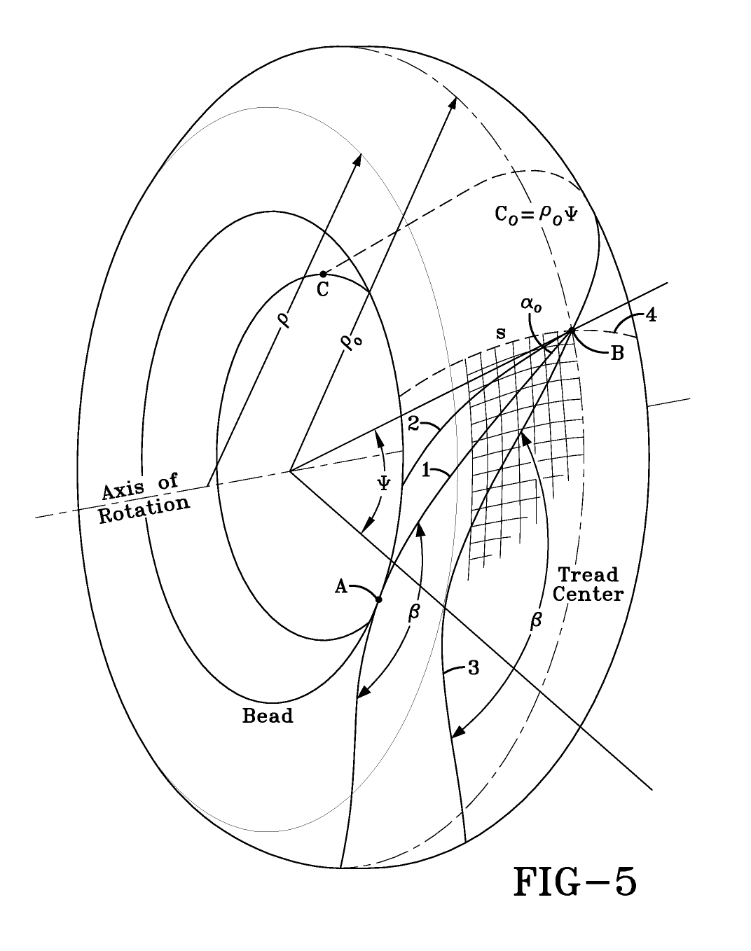

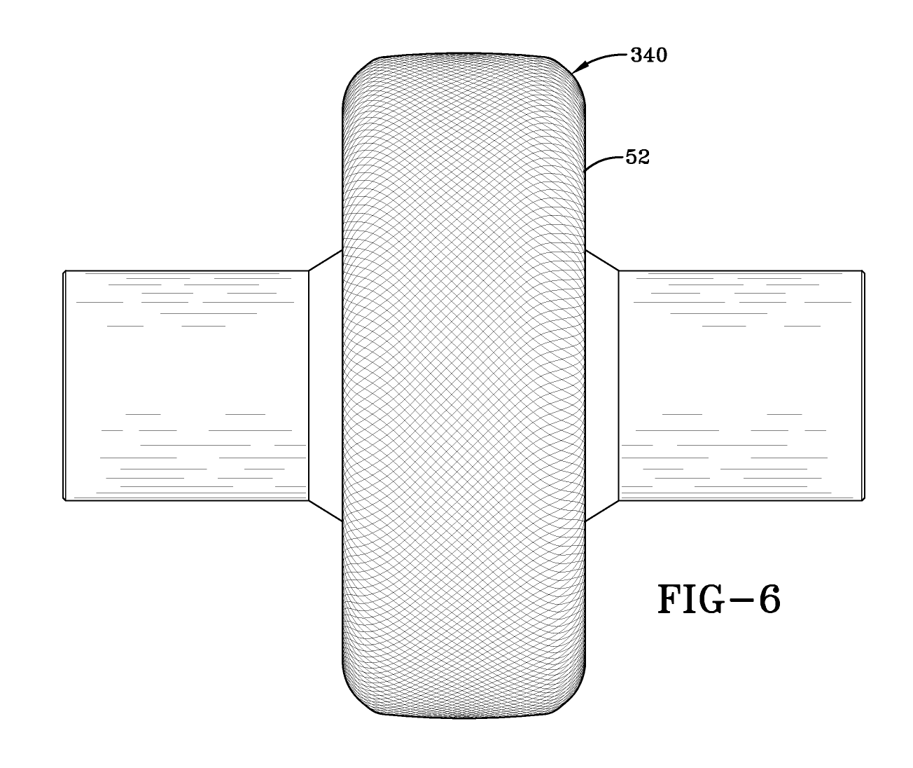

FIG. 5 illustrates several different ply path curves of a tire having geodesic cords. One well known embodiment of a geodesic tire is the radial tire and is shown as curve 4, wherein the cords have an angle α of 90 degrees with respect to the circumferential plane. Curves 1, 2 and 3 of FIG. 5 also illustrate other geodesic cord configurations. Curve 1 is a special case of a geodesic cord pattern wherein the cord is tangent to the bead circle, and is referred to herein as an orbital ply. FIGS. 4A-4B illustrate a carcass 340 having an orbital ply configuration and in various stages of completion. For curve 1 of FIG. 5, the following equation applies:

At ρ=ρbead, the angle α is zero because the cords are tangent to the bead.

α=cos⁻¹(ρbead/ρ)

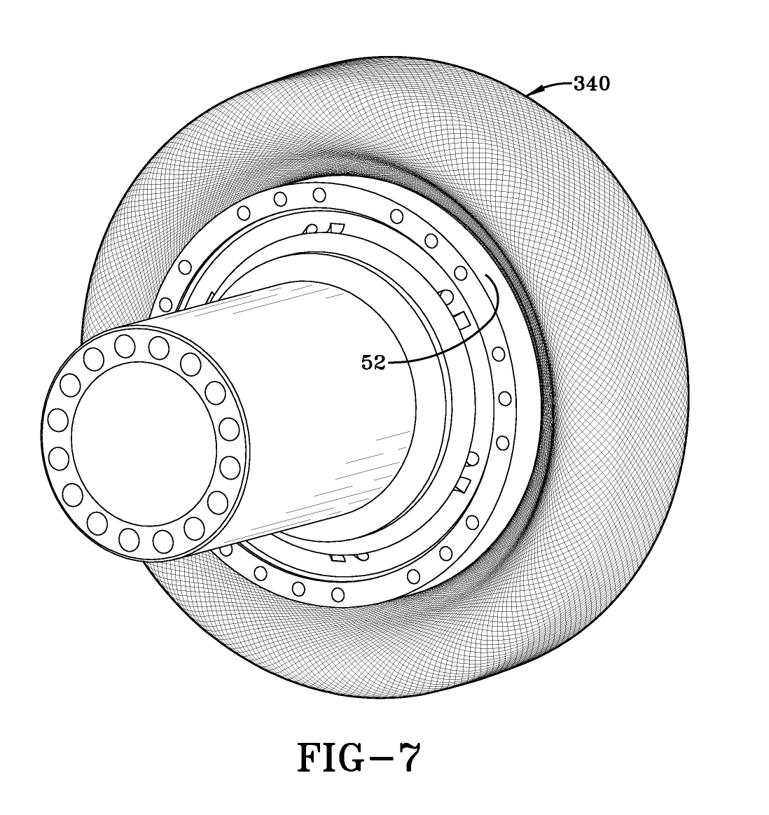

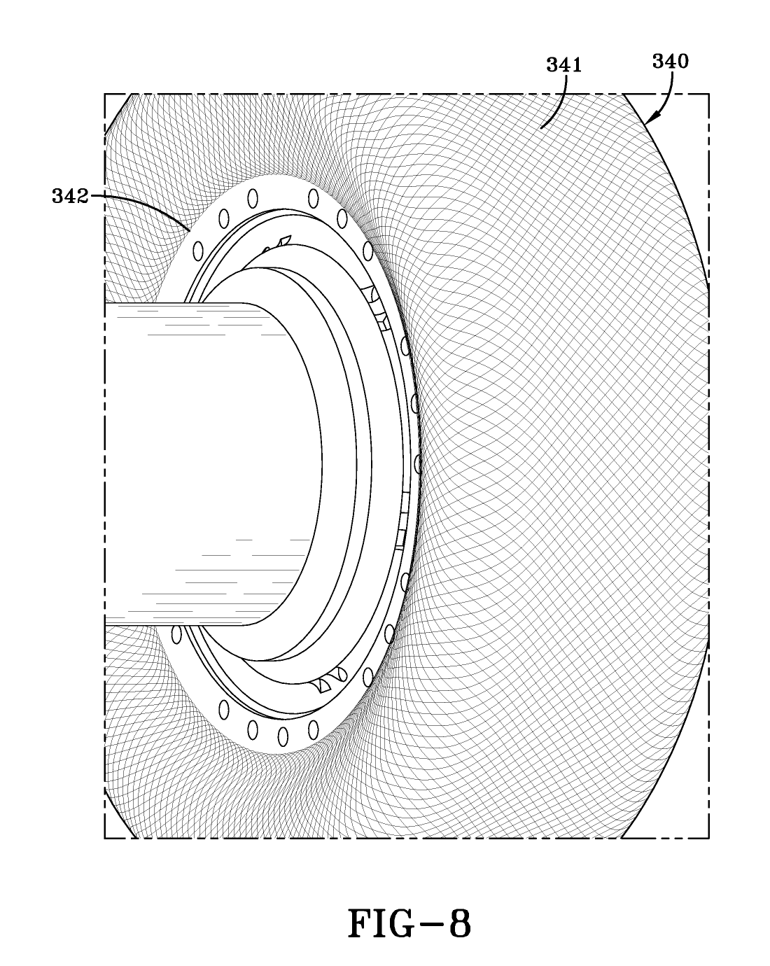

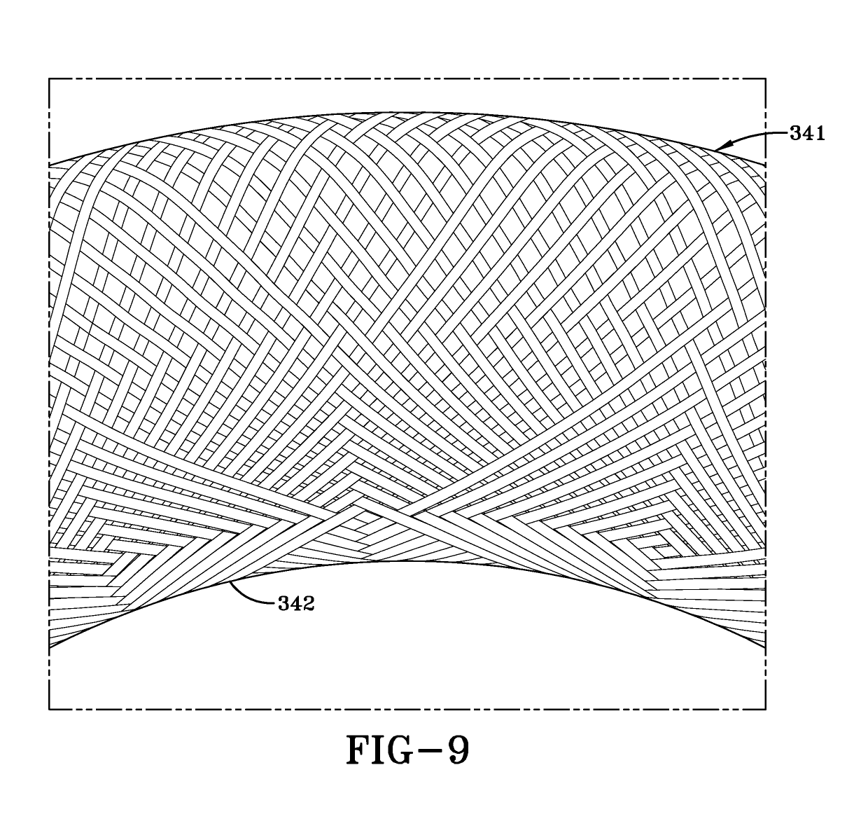

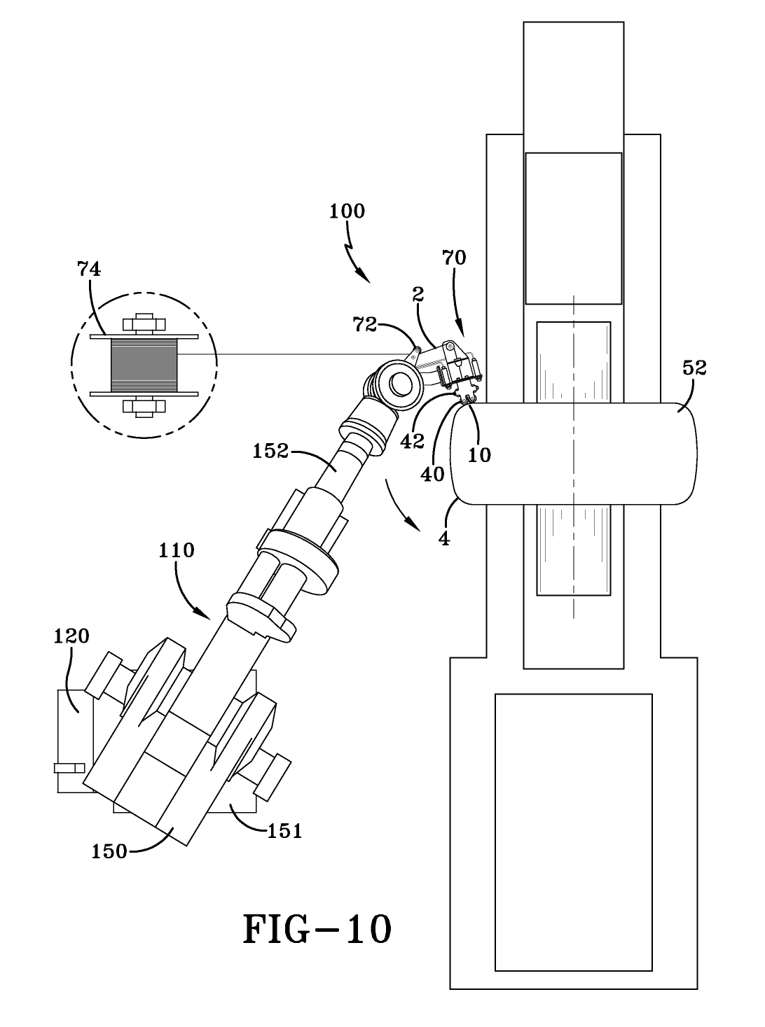

FIGS. 6-9 illustrate a first embodiment of a green tire carcass of the present invention. The tire is illustrated as a passenger tire, but is not limited to same. The cords of the carcass are arranged in a geodesic orbital pattern wherein the cords are tangent to the bead radius of the tire. The close proximity of the cords results in a very large buildup of cord material in the bead area. In order to overcome this inherent disadvantage, the inventors modified the ply layup as described in more detail, below.

### Apparatus

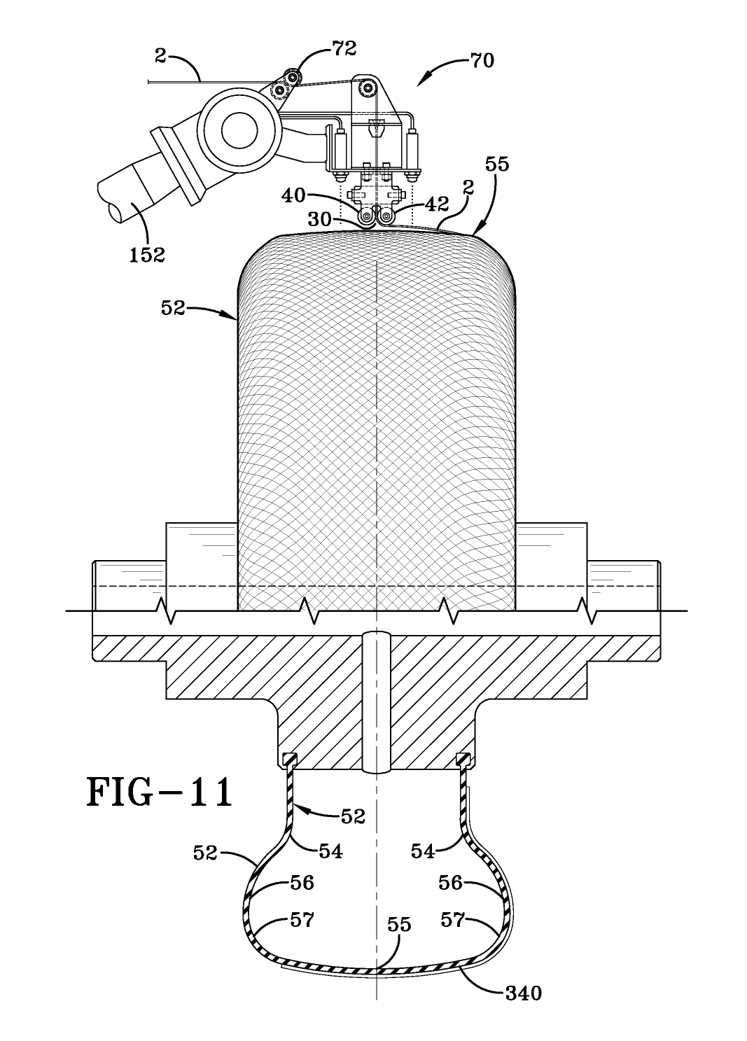

In a first embodiment of the invention, the tire 300 having a geodesic carcass is formed on a torus shaped core or tire blank 52. The outer core surface is preferably shaped to closely match the inner shape of the tire. The core is rotatably mounted about its axis of rotation and is shown in FIGS. 10 and 11. The core may be collapsible or formed in sections for ease of removal from the tire. The core may also contain internal heaters to partially vulcanize the inner liner on the core.

Next, an inner liner 342 is applied to the core. The inner liner may be applied by a gear pump extruder using strips of rubber or in sheet form or by conventional methods known to those skilled in the art. An optional bead, preferably a column bead 355 of 4 or more wires may be applied in the bead area over the inner liner. The inserts 344,350 are applied over the inner liner.

Next, a strip of rubber having one or more rubber coated cords 2 is applied directly onto the core over the inner liner and inserts as the core is rotated. With reference to FIGS. 10-11, a perspective view of an apparatus 100 in accordance with the present invention is illustrated. As shown the apparatus 100 has a guide means which has a robotic computer controlled system 110 for placing the cord 2 onto the toroidal surface of core 52. The robotic computer controlled system 110 has a computer 120 and preprogrammed software which dictates the ply path to be used for a particular tire size. Each movement of the system 110 can be articulated with very precise movements.

The robot 150 which is mounted on a pedestal 151 has a robotic arm 152 which can be moved in preferably six axes. The manipulating arm 152 has a ply mechanism 70 attached as shown. The robotic arm 152 feeds the ply cord 2 in predetermined paths 10. The computer control system coordinates the rotation of the toroidal core 52 and the movement of the ply mechanism 70.

The movement of the ply mechanism 70 permits convex curvatures to be coupled to concave curvatures near the bead areas thus mimicking the as molded shape of the tire.

With reference to FIG. 11, a cross-sectional view of the toroidal core 52 is shown. As illustrated, the radially inner portions 54 on each side 56 of the toroidal mandrel 52 have a concave curvature that extends radially outward toward the crown area 55 of the toroidal mandrel 52. As the concave cross section extends radially outward toward the upper sidewall portion 57, the curvature transitions to a convex curvature in what is otherwise known as the crown area 55 of the toroidal mandrel 52. This cross section very closely duplicates the molded cross section of a tire.

To advance the cords 2 on a specified geodesic path 10, the mechanism 70 may contain one or more rollers. Two pairs of rollers 40, 42 are shown with the second pair 42 placed 90° relative to the first pair 40 and in a physical space of about one inch above the first pair 40 and forms a center opening 30 between the two pairs of rollers which enables the cord path 10 to be maintained in this center. As illustrated, the cords 2 are held in place by a combination of embedding the cord into the elastomeric compound previously placed onto the toroidal surface and the surface tackiness of the uncured compound. Once the cords 2 are properly applied around the entire circumference of the toroidal surface, a subsequent lamination of elastomeric topcoat compound (not shown) can be used to complete the construction of the ply 20.

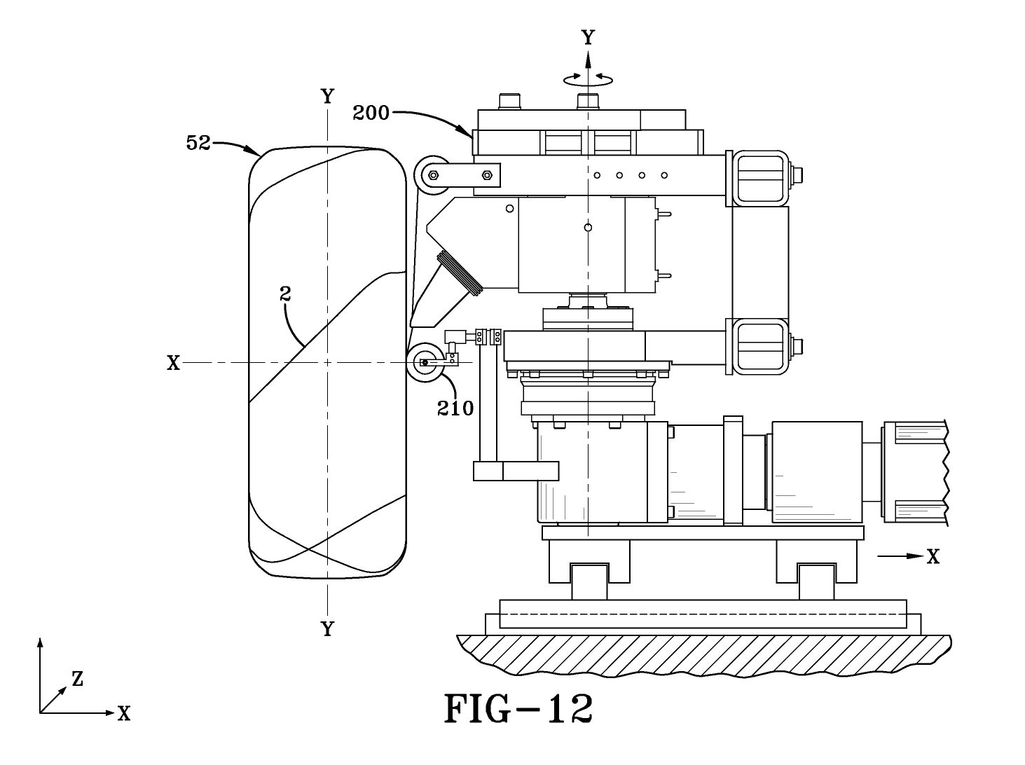

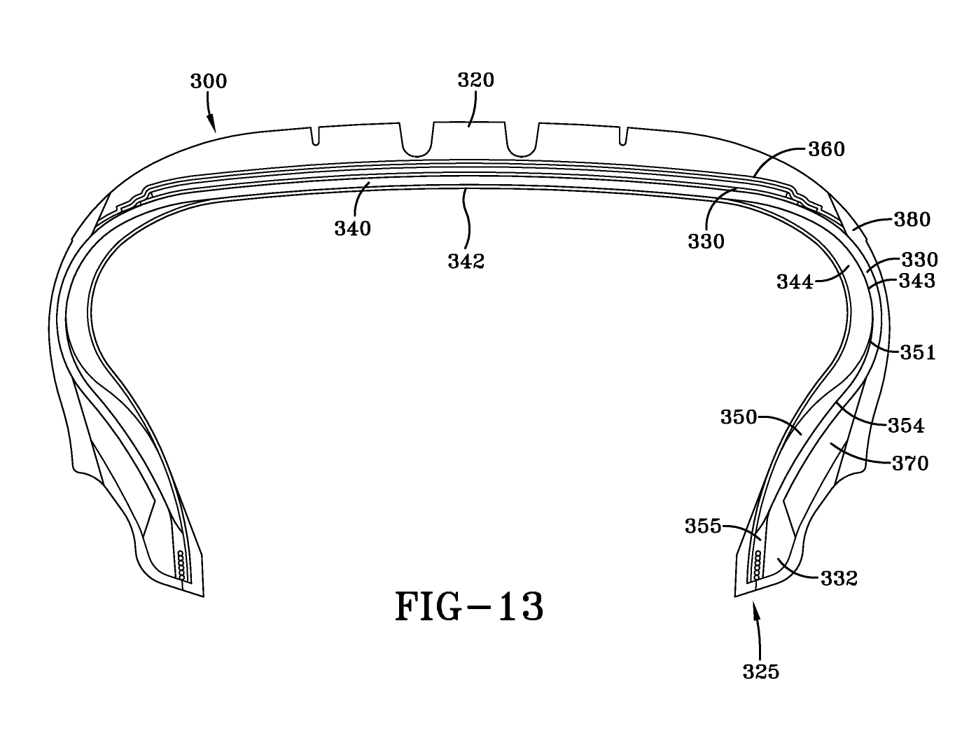

A second embodiment of an apparatus suitable for applying ply in a geodesic pattern onto a core is shown in FIG. 12. The apparatus includes a ply applier head 200 which is rotatably mounted about a Y axis. The ply applier head 200 can rotate about the Y axis +/−100 degrees. The rotation of the ply applier head 200 is necessary to apply the cord in the shoulder and bead area. The ply applier head 200 can thus rotate about rotatable core 52 on each side in order to place the ply in the sidewall and bead area. The ply applier head 200 is mounted to a support frame assembly which can translate in the X, Y and Z axis. The ply applier head has an outlet 202 for applying one or more cords 2. The cords may be in a strip form and comprise one or more rubber coated cords. Located adjacent the ply applier head 200 is a roller 210 which is pivotally mounted about an X axis so that the roller can freely swivel to follow the cord trajectory. The ply applier head and stitcher mechanism are precisely controlled by a computer controller to ensure accuracy on placement of the ply. The tire core is rotated as the cord is applied. The tire core is rotated discontinuously in order to time the motion of the head with the core. The ply applier head and stitcher apparatus is specially adapted to apply cord to the sidewalls of the tire core and down to and including the bead area.

The strip of rubber coated cords are applied to the core in a pattern following the mathematical equation ρ cos α=constant. FIG. 5 illustrates ply curves 1, 2, and 3 having geodesic ply paths. Curves 2 and 3 illustrate an angle β, which is the angle the ply makes with itself at any point. For the invention, the angle β is selected to be in the range strictly greater than 90 degrees to about 180 degrees. Preferably, the geodesic path (or orbital path) of the invention is ply curve 2 with β about equal to 180 degrees. For ply curve 2, if a point on the curve is selected such as point A, the angle of ply approaching point A will be equal to about 180 degrees. Likewise, the angle of the ply going away from point A will also be about 180 degrees. Thus for any point on curve 2, the angle of ply approaching the point and leaving the point will be about 180 degrees, preferably substantially 180 degrees.

As shown in FIG. 5, the angle α₀ is selected so that the cord is tangent to the bead. Starting at a point A, the cord is tangent to the bead. Curve 1 of FIG. 5 illustrates the cord path from point A to the center crown point B, which is an inflection point. The cord continues to the other side of the tire wherein the cord is tangent at point C. The process is repeated until there is sufficient coverage of the core. Depending on the cord size and type selection, the cords are wound for 300 to 450 revolutions to form the carcass. Since the cords are tangent to the bead at multiple locations, the build up of the cords in the bead area form a bead.

As described above, the ply cords are applied to the core in a pattern following the mathematical equation ρ cos α=constant. Using a three dimensional grid of data points of the core, a calculation of all of the discrete cord data points satisfying the mathematical equation ρ cos α=constant may be determined. The three dimensional data set of the core is preferably X,Y,Ψ coordinates, as shown in FIG. 5. A starting point for the calculation is then selected. The starting point is preferably point A of FIG. 5, which is the point of tangency of the cord at the bead location. An ending point is then selected, and is preferably point C of FIG. 5. Point C represents the point of tangency on the opposite side of the tire compared to point A. Next the change in W is calculated from point A to point C. The desired cord path from the starting point A to ending point C is then determined from the three dimensional data set using a method to determine the minimum distance from point A to point C. Preferably, dynamic programming control methodology is used wherein the three dimensional minimum distance is calculated from point A to point C. A computer algorithm may be used which calculates each distance for all possible paths of the three dimensional data set from point A to point C, and then selects the path of minimal distance. The path of minimum distance from point A to point C represents the geodesic path. The discrete data points are stored into an array and used by the computer control system to define the cord path. The process is them repeated from point C to the next point of tangency and repeated until sufficient coverage of the carcass occurs.

### Geodesic Ply with Indexing

In a variation of the invention, all of the above is the same except for the following. The strip is applied starting at a first location in a first continuous strip conforming exactly to ρ cos α=constant for N revolutions. N is an integer between 5 and 20, preferably 8 and 12, and more preferable about 9. After N revolutions, the starting point of the strip for the second continuous strip is moved to a second location which is located adjacent to the first location. The strip is not cut and remains continuous, although the strip could be cut and indexed to the starting location. The above steps are repeated until there is sufficient ply coverage, which is typically 300 or more revolutions. The inventors have found that this small adjustment helps the ply spacing to be more uniform.

### Radius Variation

In yet another variation of the invention, all of the above is the same except for the following. In order to reduce the buildup at the bead area, the radius ρ is varied in the radial direction by +/− delta in the bead area of the tire on intervals of Q revolutions. Delta may range from about 2 mm to about 20 mm, more preferably from about 3 to about 10 mm, and most preferably about 4 to about 6 mm. The radius is preferably varied in a randomized fashion. Thus for example, if Q is 100, then for every 100 revolutions, the radius may be lengthened about 5 mm, and in the second 100 revolutions, the radius may be shortened about 5 mm.

Another way of varying the radius is at every Qth revolution, the radius is adjusted so that the point of tangency is incrementally shortened by gamma in the radial direction, wherein gamma varies from about 3 mm to about 10 mm. Q may range from about 80 to about 150, and more preferably from about 90 to about 120 revolutions. Thus for example, Q may be about 100 revolutions, and gamma may be about 5 mm. Thus for every 100 revolutions, the radius may be shortened by 5 mm in the radial direction. The variation of the radius may be preferably combined with the indexing as described above.

### Axial Variation

In yet another variation, all of the above is the same as described in any of the above embodiments, except for the following. In order to account for the buildup at the bead area, the cord axial dimension is increased in the bead area. Thus there is a deviation in the geodesic equation at the bead area. In the vicinity of the bead area, wherein ρ is <some value, a new X value is calculated to account for the buildup of material in the bead area. A new X value is calculated based upon the cord thickness. The new X value may be determined using a quadratic equation. The p and a values remain unchanged.

### Dwell Variation

In yet another variation, all of the above is the same as described in any of the above embodiments, except for the following. In order to reduce the buildup at the bead area, a dwell angle Ψ is utilized. Thus instead of there being one point of tangency at the bead, the angle W is dwelled a small amount on the order of about 5 degrees or less while the other variables remain unchanged. The dwell variation is useful to fill in gaps of the cord in the bead area.

### Cord Construction

The cord may comprise one or more rubber coated cords which may be polyester, nylon, rayon, steel, flexten or aramid.

Preferably, the ply has an orbital ply configuration, i.e., extends across from shoulder to shoulder following the equation ρ cos α, and is tangent to the bead at multiple locations. It is more preferred that in the bead region, the ply radius is randomized +/−5 mm to prevent buildup of ply in the bead area. It is additionally preferred that as the ply is wound on the core that the computer controller adjusts the bead area axially outward to account for the bead build up. It is additionally preferred that the ply is wound sufficiently thick to form a layer of ply having the equivalent thickness of two layers of ply.

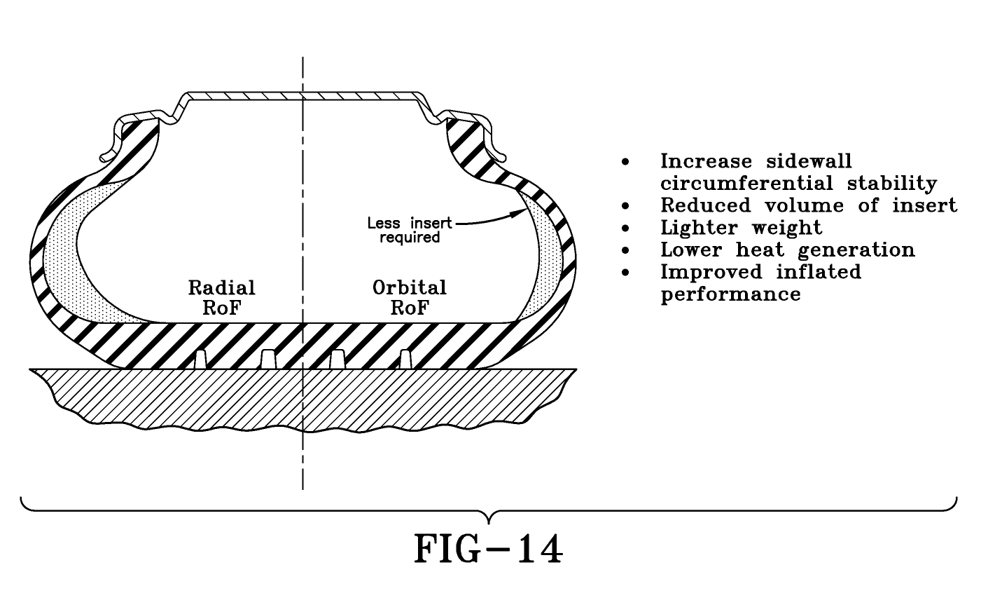

FIG. 14 compares the cross-sectional profile of a typical radial run flat tire as compared to the tire of the present invention. For the same load carrying capacity, the radial tire requires a much thicker sidewall as well as a much thicker insert. The tire of the present invention due to its increased load carrying capacity has the benefit of a reduced volume or size of the insert and the sidewall. The tire of the present invention due to the ply configuration has increased circumferential stability. The tire of the present invention thus enjoys the benefits of lower weight, lower heat generation and improved inflated performance.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic run flat tire comprising: a carcass, a tread, and a belt reinforcing structure located radially outward of the carcass and radially inward of the tread, a pair of sidewalls, each sidewall located radially outward of one of the pair of bead portions, and a first insert, wherein the carcass further includes a first reinforcing ply extending under the tread, and being formed of one or more cords wound in a geodesic pattern.

2. The pneumatic run flat tire of claim 1 wherein on each sidewall portion of the tire the angle β of the ply with respect to itself is strictly greater than 90 degrees.

3. The tire of claim 1 wherein the tire further comprises two column beads.

4. The tire of claim 1 wherein the ply is formed of a single continuous cord.

5. The tire of claim 1 wherein the ply is formed from a continuous strip of one or more reinforcement cords.

6. The tire of claim 1 wherein the angle β of the ply with respect to itself is substantially 180 degrees throughout the layer of ply.

7. The tire of claim 1 wherein the angle β of the ply is a constant throughout the layer of ply.

8. The tire of claim 1 wherein the angle β of the ply with respect to itself is 180 degrees or less throughout the layer of ply.

9. The tire of claim 1 wherein the cord is tangent to a point located at the radially innermost point of each sidewall.

10. The tire of claim 1 further comprising a bead.

11. The tire of claim 1 wherein the cords are aramid.

12. The tire of claim 1 wherein the cords are polyester.

13. The tire of claim 1 wherein the cords have filaments formed of aramid and polyester.

14. The pneumatic run flat tire of claim 1 wherein the geodesic pattern extends from a first shoulder to a second shoulder opposite said first shoulder and being tangent to the bead at a location between said first shoulder and said second shoulder.

15. The pneumatic run flat tire of claim 1 wherein the first insert and a second insert are positioned between an innerliner and the first reinforcing ply.

16. The pneumatic run flat tire of claim 2 wherein a radially inner end of the first insert overlaps with a radially outer end of the second insert.

17. The tire of claim 1 wherein the bead portion is a column bead located axially inward of the ply.

18. The tire of claim 1 wherein the first insert has a thickness in the range of about 4 to about 6 mm.

19. The tire of claim 1 wherein the first insert has a shore A hardness value less than the shore A hardness of the second insert.

20. The tire of claim 1 wherein the first insert has a shore A hardness measured at 23 degrees C. in the range of about 55 to about 65.

21. The tire of claim 1 wherein the second insert has a shore A hardness measured at 23 degrees C. in the range of about 60 to about 80.

22. A method of making a tire comprising the steps of
providing a rotatable core having the same dimensions as a finished tire;
forming a inner liner of said rotatable core;
placing a column bead on each side of the core in the bead area;
placing one or more inserts in the shoulder area of the tire;
forming a first layer of ply by winding a strip of one or more rubber coated cords onto the core in a geodesic pattern extending from a first shoulder to a second shoulder opposite said first shoulder and being tangent to the bead area at a location between said first shoulder and said second shoulder.

23. The method of claim 1 wherein the strip is continuous.

24. The method of claim 1 wherein the core is not rotated at a constant speed.

25. The method of claim 22 wherein the angle β of the ply is strictly greater than 90 degrees.

26. The method of claim 22 wherein the angle β of the ply is about 180 degrees.

27. The method of claim 22 wherein the angle β of the ply is substantially 180 degrees.

28. The method of claim 22 wherein for at least one revolution of the ply around the core, the radius of the ply is adjusted plus or minus delta.

29. The method of claim 22 wherein for at least three revolutions of the ply around the core, the radius of the ply is adjusted plus or minus delta in a random fashion.

30. The method of claim 22 wherein for every revolution of the ply around the core, the radius of the ply is adjusted plus or minus delta incrementally.

31. The method of claim 22 wherein the radius is adjusted at least one revolution so that the point of tangency is shortened by gamma in the radial direction, wherein gamma varies from about 3 mm to about 10 mm.

32. The method of claim 1 or 22 wherein at the point that the cord is tangent to the radially innermost point of the sidewall, the geodesic pattern is interrupted and the ply is dwelled a dwell angle Ψ of 5 degrees or less.

33. The method of claim 32 wherein the ply is dwelled at the same radial and axial location as the point of tangency.
